(19) United States
(12) Patent Application Publication
(10) Pub. No.: US 2013/0125012 A1
(43) Pub. Date: May 16, 2013

(54) DYNAMIC USER CUSTOMIZED WEB ADVERTISEMENTS

(71) Applicants: Dinesh GANESAN, Ellicott City, MD (US); Saivivek THIYAGARAJAN, Ashburn, VA (US); Rohit P. DOOBAY, Odessa, FL (US)

(72) Inventors: Dinesh GANESAN, Ellicott City, MD (US); Saivivek THIYAGARAJAN, Ashburn, VA (US); Rohit P. DOOBAY, Odessa, FL (US)

(73) Assignee: VERIZON PATENT AND LICENSING INC., Basking Ridge, NJ (US)

(21) Appl. No.: 13/297,795

(22) Filed: Nov. 16, 2011

(51) Int. Cl. G06F 3/048

(52) U.S. Cl. 715/745

(57) ABSTRACT

A device receives a user profile associated with a user of a user device, where the user profile is generated based on information associated with one or more transactions performed by the user, via the user device, with a first web site. The device also receives, from a second web site, a cookie associated with the user device. The device further generates, based on the user profile and when the cookie is received, an advertisement customized to the user, and provides, to the second web site, the advertisement customized to the user.

### BACKGROUND

Online advertisements and associated advertising links may be provided to users when they visit certain web sites. When a particular advertising link is of interest to a user, a user may select (or click on) the advertising link, which may cause the user's web browser to visit a web page belonging to an advertiser associated with the advertising link. Web site owners may charge fees, to the advertisers, for displaying advertisements on their web pages. Advertisement fees may be charged on a cost-per-click (CPC) basis, a cost-per-impression (CPM) basis, etc.

### BRIEF DESCRIPTION OF THE DRAWINGS

FIG. 1 is a diagram of an example network in which systems and/or methods described herein may be implemented;

FIG. 2 is a diagram of example components of a device that may correspond to one of the devices of the network depicted in FIG. 1;

FIG. 3 is a diagram of example operations capable of being performed by an example portion of the network in FIG. 1;

FIGS. 4A-4C are diagrams of example operations capable of being performed by another example portion of the network in FIG. 1;

FIG. 5 is a diagram of example functional components of an advertisement (ad) server of FIG. 1;

FIG. 6 is a diagram of an example user interface capable of being generated or provided by a user device, the ad server, and/or a provider server of FIG. 1;

FIG. 7 is a diagram of another example user interface capable of being generated or provided by the user device, the ad server, and/or the provider server of FIG. 1;

FIG. 8 is a diagram of still another example user interface capable of being generated or provided by the user device, the ad server, and/or the provider server of FIG. 1; and

FIG. 9 is a flow chart of another example process for providing dynamic user customized web advertisements according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may provide web advertisements (e.g., banner advertisements) that are dynamically customized to a user based on a user profile and based on the user's transactions with a particular provider. For example, the systems and/or methods may generate dynamic ad content that is customized based on a user profile. The dynamic ad content may include service qualification information and/or product/price offering information. The systems and/or methods may determine the dynamic ad content expeditiously in order to provide the dynamic ad content as quickly as possible. For example, the systems and/or methods may utilize cloud computing services, synchronous technologies, and/or asynchronous technologies to quickly render the dynamic ad content. The systems and/or methods may enable the particular provider to retarget advertisements to the user with the user's specific interests and to communicate information about optimal products and/or services to the user via other provider web sites. The systems and/or method may also enable the particular provider to provide the products and/or services to the user in real time and to improve online channel sales at lower costs.

In one example implementation, an ad server may receive user information associated with a user of a first web site of a particular provider, and may receive transaction information associated with one or more transactions performed by the user via the first web site. The ad server may create a user profile for the user based on the user information and/or the transaction information. Alternatively, or additionally, the ad server may receive the user profile from the particular provider or from an entity associated with the particular provider. If the ad server receives a cookie (or some other user identifier), associated with a user device of the user, via a second web site, the ad server may provide an ad customized to the user, based on the user profile and/or the cookie, to the second web site. If the ad server receives an Internet protocol (IP) address of the user device from the second web site, the ad server may determine a location of the user based on the IP address. The ad server may provide, to the second web site, an ad customized to the location when the location is supported by the particular provider, or may provide a generic ad to the second web site when the location is unsupported by the particular provider.

As used herein, the terms “customer” and/or “user” may be used interchangeably. Also, the terms “customer and/or “user” are intended to be broadly interpreted to include a user device or a user of a user device.

A “product,” as the term is used herein, is to be broadly interpreted to include anything that may be marketed or sold as a commodity or a good. For example, a product may include gas, bread, coffee, bottled water, milk, soft drinks, pet food, beer, diesel fuel, meat, fruit, etc.

A “service,” as the term is used herein, is to be broadly interpreted to include any act or variety of work done for others (e.g., for compensation). For example, a service may include a repair service (e.g., for a product), a warranty (e.g., for a product), telecommunication services (e.g., telephone services, Internet services, network services, radio services, television services, video services, etc.), etc.

The term “transaction,” as used herein, is intended to be broadly construed to include reviewing one or more products and/or services offered by the particular provider, purchasing one or more products and/or services offered by the particular provider, performing account-related actions with the particular provider, etc.

The term “component,” as used herein, is intended to be broadly construed to include hardware (e.g., a processor, a microprocessor, an application-specific integrated circuit (ASIC), a field-programmable gate array (FPGA), a chip, a memory device (e.g., a read only memory (ROM), a random access memory (RAM), etc.), etc.) or a combination of hardware and software (e.g., a processor, microprocessor, ASIC, etc. executing software contained in a memory device).

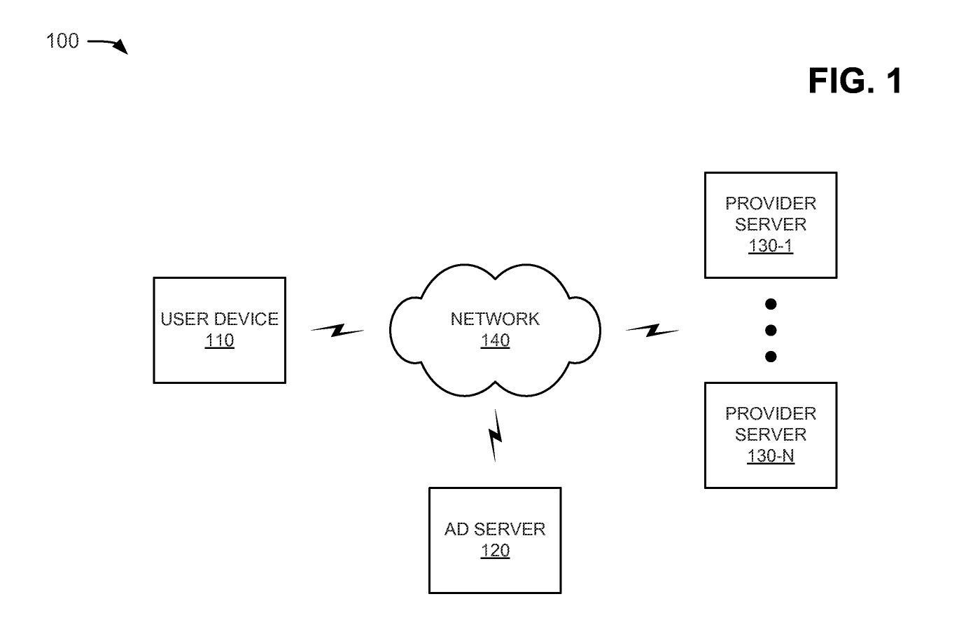

FIG. 1 is a diagram of an example network 100 in which systems and/or methods described herein may be implemented. As illustrated, network 100 may include a user device 110, an advertisement (ad) server 120, one or more provider servers 130-1 through 130-N (collectively referred to herein as “provider servers 130,” and, in some instances, singularly as “provider server 130”), and a network 140. Devices and/or networks of network 100 may interconnect via wired and/or wireless connections. One user device 110, one ad server 120, two provider servers 130, and one network 140 have been illustrated in FIG. 1 for simplicity. In practice, there may be more user devices 110, ad servers 120, provider servers 130, and/or networks 140.

User device 110 may include a radiotelephone; a personal communications system (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a tablet computer; a desktop computer; a workstation computer; or other types of computation and/or communication devices. In one example, user device 110 may include a device that is capable of communicating with ad server 120 and/or provider servers 130 via network 140.

Ad server 120 may include one or more server devices, or other types of computation or communication devices, that gather, process, search, and/or provide information in a manner described herein. In one example implementation, ad server 120 may include a computer system, an application, and/or a broadcasting device capable of providing advertisements, promotional information, commercials, coupons, instructions, and/or other information to user device 110 via one or more provider servers 130.

Provider server 130 may include one or more server devices, or other types of computation or communication devices, that gather, process, search, and/or provide information in a manner described herein. In one example implementation, provider server 130 may offer products and/or services, via a web site, to a user of user device 110. For example, provider server 130 may provide online search engine services, news services, weather services, dictionary services, and/or other online services to the user of user device 110. In one implementation, a particular provider server 130 (e.g., provider server 130-1) may collect information associated with the user when the user visits a web site provided by particular provider server 130-1. The particular provider server 130-1 may also collect transaction information associated with transactions performed by the user during the visit to the web site. The particular provider server 130-1 may provide the collected information to ad server 120, and ad server 120 may utilize the collected information to serve particular ads to the user when the user visits web sites provided by the other provider servers 130 (e.g., provider servers 130-2 through 130-N).

Network 140 may include a local area network (LAN), a wide area network (WAN), a metropolitan area network (MAN), a telephone network, such as the Public Switched Telephone Network (PSTN), an intranet, the Internet, an optical fiber (or fiber optic)-based network, a cable television network, a satellite television network, or a combination of networks.

Although FIG. 1 shows example devices/networks of network 100, in other implementations, network 100 may include fewer devices/networks, different devices/networks, differently arranged devices/networks, or additional devices/networks than depicted in FIG. 1. Alternatively, or additionally, one or more devices/networks of network 100 may perform one or more other tasks described as being performed by one or more other devices/networks of network 100.

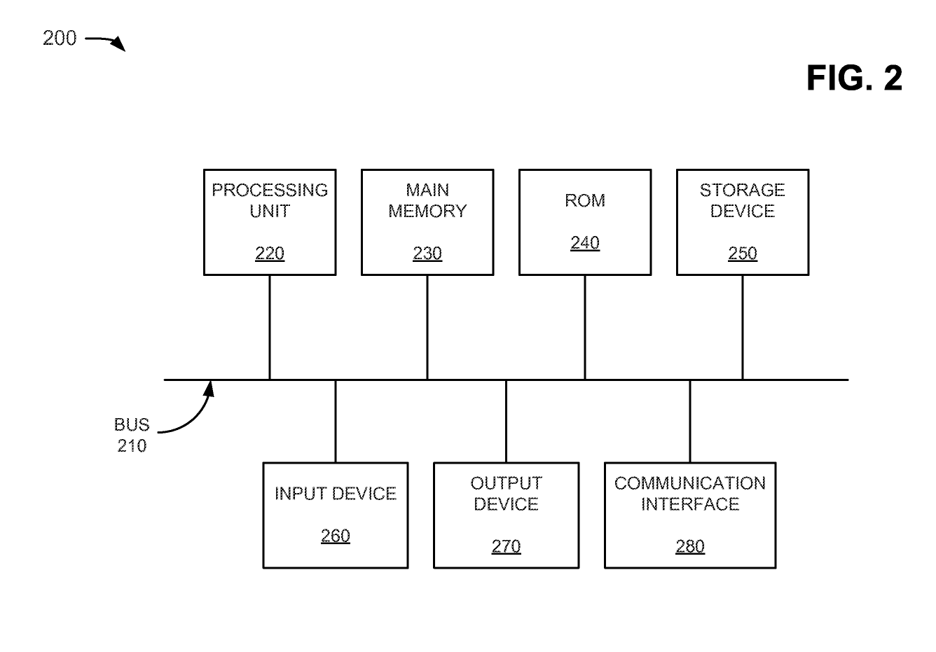

FIG. 2 is an example diagram of a device 200 that may correspond to one or more devices of network 100. In one example implementation, one or more of the devices of network 100 may include one or more devices 200 or one or more components of device 200. As illustrated, device 200 may include a bus 210, a processing unit 220, a main memory 230, a ROM 240, a storage device 250, an input device 260, an output device 270, and/or a communication interface 280. Bus 210 may include a path that permits communication among the components of device 200.

Processing unit 220 may include one or more processors, microprocessors, or other types of processing units that may interpret and execute instructions. In one example, processing unit 220 may be implemented as or include one or more ASICs, FPGAs, or the like. Main memory 230 may include one or RAMs or other types of dynamic storage devices that may store information and instructions for execution by processing unit 220. ROM 240 may include one or more ROM devices or other types of static storage devices that may store static information and/or instructions for use by processing unit 220. Storage device 250 may include a magnetic and/or optical recording medium and its corresponding drive.

Input device 260 may include a mechanism that permits a user to input information to device 200, such as a keyboard, a mouse, a pen, a microphone, voice recognition and/or biometric mechanisms, a remote control, a touch screen, etc. Output device 270 may include a mechanism that outputs information to the user, including a display, a printer, a speaker, etc. Communication interface 280 may include any transceiver-like mechanism that enables device 200 to communicate with other devices, networks, and/or systems. For example, communication interface 280 may include mechanisms for communicating with another device or system via a network.

As described herein, device 200 may perform certain operations in response to processing unit 220 executing software instructions contained in a computer-readable medium, such as main memory 230. A computer-readable medium may be defined as a non-transitory memory device. A memory device may include space within a single physical memory device or spread across multiple physical memory devices. The software instructions may be read into main memory 230 from another computer-readable medium, such as storage device 250, or from another device via communication interface 280. The software instructions contained in main memory 230 may cause processing unit 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows example components of device 200, in other implementations, device 200 may contain fewer components, different components, differently arranged components, or additional components than depicted in FIG. 2. Alternatively, or additionally, one or more components of device 200 may perform one or more other tasks described as being performed by one or more other components of device 200.

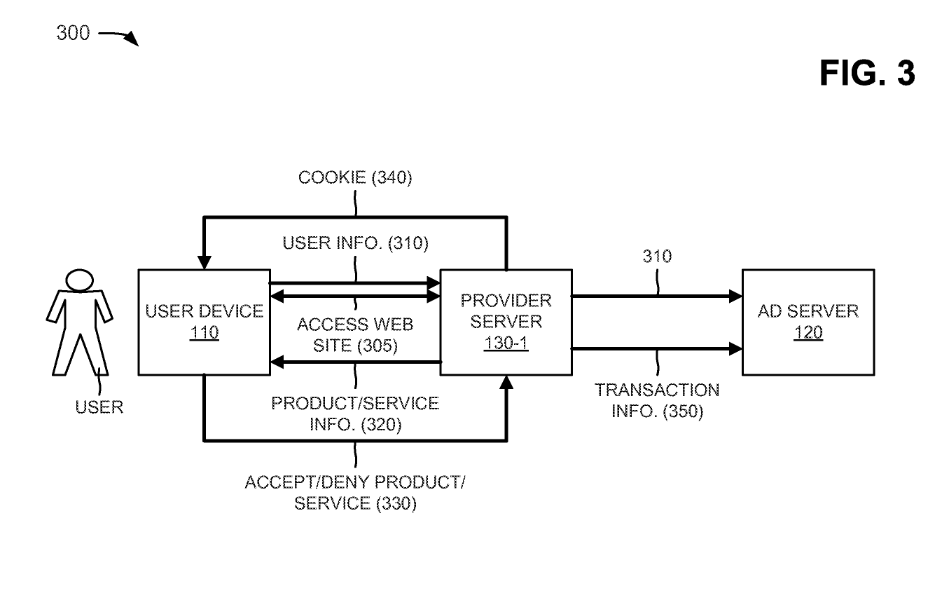

FIG. 3 is a diagram of example operations capable of being performed by an example portion 300 of network 100 (FIG. 1). As shown, network portion 300 may include user device 110, ad server 120, and provider server 130-1. User device 110, ad server 120, and/or provider server 130-1 may include the features described above in connection with, for example, one or more of FIGS. 1 and 2.

As further shown in FIG. 3, a user, via user device 110, may access a web site provided by provider server 130-1, as indicated by reference number 305. In one example implementation, provider server 130-1 may provide a web site, to user device 110, from which the user may review and/or purchase a variety of products and/or services offered by provider server 130-1. For example, if provider server 130-1 is associated with a telecommunications provider, the web site may offer services, such as wireless telephone services, television services, Internet access services, etc. and/or products, such as wireless telephones, wireless telephone accessories, smart phones, tablet computers, etc. The user may provide user information 310 to user device 110, and user device 110 may provide user information 310 to provider server 130-1. User information 310 may include a name, a home address, a telephone number, credit card information, a shipping address, etc. associated with the user, an IP address associated with user device 110, etc. In one example, provider server 130-1 may request user information 310 via the web site.

Provider server 130-1 may provide product/service information 320 to user device 110, and user device 110 may display product/service information 320 to the user. Product/service information 320 may include information associated with products and/or services offered by provider server 130-1 via the web site. For example, in the telecommunications provider scenario, product/service information 320 may include information associated with products, such as wireless telephones, wireless telephone accessories, smart phones, tablet computers, etc., and information associated with services, such as wireless telephone services, television services, Internet access services, etc. The user may review product/service information 320 via user device 110, and may decide whether to accept (e.g., purchase) or deny (e.g., not purchase) a product and/or a service provided by product/service information 320, as indicated by reference number 330. User device 110 may provide, to provider server 130-1, information 330 associated with whether the user accepts or denies the product and/or the service. In one example implementation, the offering of products and/or services, via product/service information 320, and the acceptance or denial of the products and/or services by the user may be referred to as “transactions” with provider server 130-1.

In one example implementation, provider server 130-1 may provide a cookie 340 to user device 110, and user device 110 may store cookie 340. In one example, cookie 340 may include a hypertext transfer protocol (HTTP) cookie, a web cookie, a browser cookie, or another type of user device 110 identifier that may be used for an origin web site (e.g., the web site provided by provider server 130-1) to send state information to a browser (e.g., executing on user device 110) and for the browser to return the state information to the origin web site. The state information may be used for authentication, identification of a user session, user's preferences, shopping cart contents, etc. In one example, if the user does not provide user information 310 to provider server 130-1, provider server 130-1 may or may not provide cookie 340 to user device 110.

As further shown in FIG. 3, provider server 130-1 may provide user information 310 and/or transaction information 350, associated with the user, to ad server 120. Transaction information 350 may include information associated with transactions performed by the user when the user visits the web site provided by provider server 130-1. For example, transaction information 350 may include information associated with products and/or services viewed by the user via the web site, products and/or services purchased by the user via the web site, whether the user accepts or denies products and/or services offered via the web site, etc. In one example implementation, transaction information 350 may include product/service information 320 and/or information 330 associated with whether the user accepts or denies the product and/or the service.

In one example implementation, ad server 120 may utilize user information 310 and/or transaction information 350 to create a user profile for the user. The user profile may include user information 310 and/or transaction information 350. Alternatively, or additionally, ad server 120 may receive the user profile directly from provider server 130-1 or from an entity associated with provider server 130-1 (e.g., a business partner). Ad server 120 may store the user profile in a database associated with ad server 120.

Although FIG. 3 shows example components of network portion 300, in other implementations, network portion 300 may include fewer components, different components, differently arranged components, or additional components than depicted in FIG. 3. Additionally, or alternatively, one or more components of network portion 300 may perform one or more other tasks described as being performed by one or more other components of network portion 300.

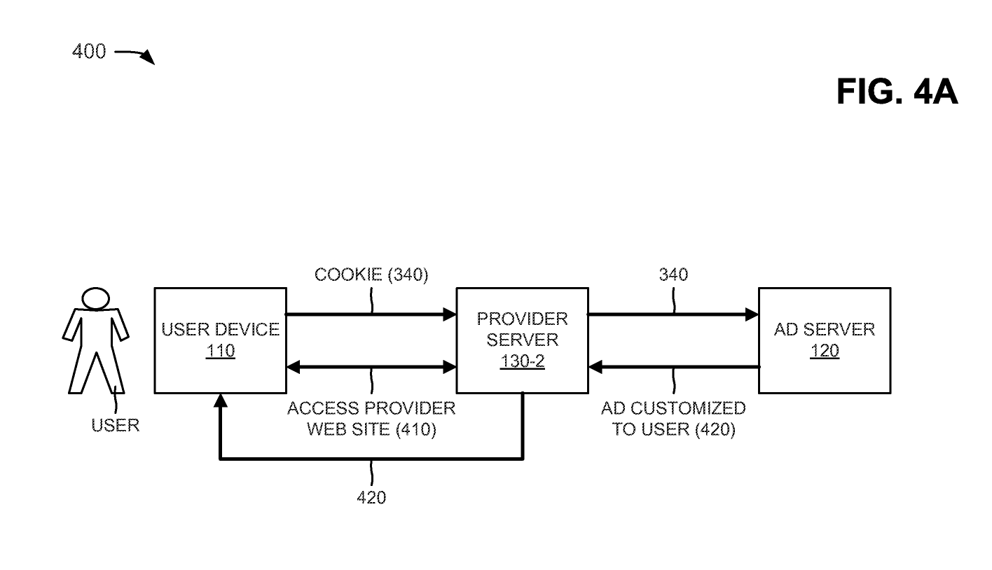

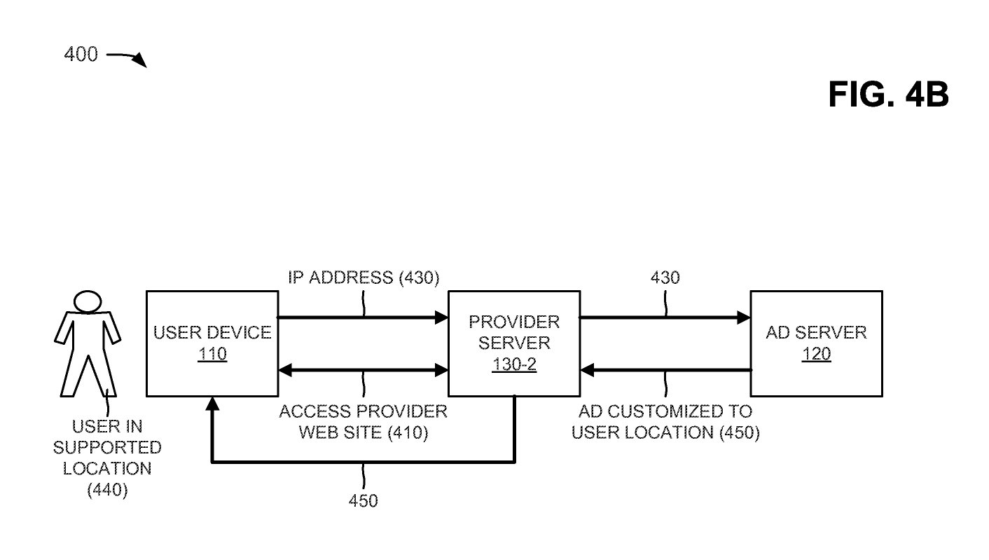

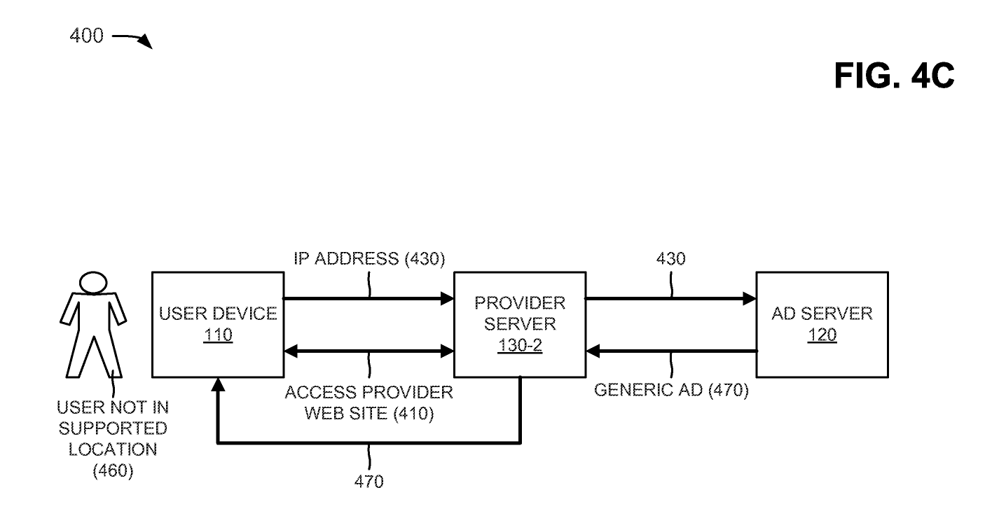

FIGS. 4A-4C are diagrams of example operations capable of being performed by another example portion 400 of network 100 (FIG. 1). As shown, network portion 400 may include user device 110, ad server 120, and provider server 130-2. User device 110, ad server 120, and/or provider server 130-2 may include the features described above in connection with, for example, one or more of FIGS. 1-3.

As further shown in FIG. 4A, a user, via user device 110, may access a web site provided by provider server 130-2, as indicated by reference number 410. In one example implementation, provider server 130-2 may provide a web site, to user device 110, from which the user may receive web services provided by provider server 130-2. For example, provider server 130-2 may provide online search engine services, news services, weather services, dictionary services, and/or other online services to user device 110 via the web site.

If the user, via user device 110, has visited the web site provided by provider server 130-1 and/or has received cookie 340 from provider server 130-1 (FIG. 3), user device 110 may provide cookie 340 to provider server 130-2, as shown in FIG. 4A. Provider server 130-2 may provide cookie 340 to ad server 120, and ad server 120 may receive cookie 340. Based on cookie 340, ad server 120 may retrieve the user profile (e.g., from the database associated with ad server 120), and may determine an ad 420 (e.g., customized to the user) based on the user profile and/or cookie 340. Ad 420 may include a banner ad, or some other type of online ad, that is unique to the user profile and/or transactions performed by the user on the web site provided by provider server 130-1.

For example, if the user utilizes television services offered by provider server 130-1, ad 420 may include advertisements for Internet or voice services offered by provider server 130-1. Alternatively, or additionally, if the user utilizes television and voice servers offered by provider server 130-1, ad 420 may include an advertisement for Internet services offered by provider server 130-1. Alternatively, or additionally, if the user did not purchase a product/service offered by provider server 130-1 because of price (e.g., as indicated by the user completing steps of the purchase except a final purchasing step), ad 420 may include an advertisement promoting a lower price for the product/service offered by provider server 130-1 (e.g., when the price is lowered). Alternatively, or additionally, if the user did not purchase a product/service offered by provider server 130-1 because the user was not eligible for the product/service (e.g., the product/service is not available at a location of the user), ad 420 may include an advertisement stating that the user is now eligible for the product/service offered by provider server 130-1.

As further shown in FIG. 4A, ad server 120 may provide ad 420 to provider server 130-2, and provider server 130-2 may embed ad 420 into a web site provided to user device 110. Ad 420 may attempt to attract traffic to the web site of provider server 130-1 (FIG. 3) by linking to the web site of provider server 130-1. In one example, ad 420 may include an image, and may employ animation, sound, and/or video to maximize presence. Provider server 130-2 may provide ad 420 to user device 110, via the web site provided by provider server 130-2. Ad 420 may be displayed to the user when a web site provided by provider server 130-2 is loaded into a web browser of user device 110. If the user, via user device 110, selects ad 420, user device 110 may be redirected to the web site provided by provider server 130-1 (FIG. 3).

As shown in FIG. 4B, the user, via user device 110, may access the web site provided by provider server 130-2, as indicated by reference number 410. In one example implementation, provider server 130-2 may provide a web site, to user device 110, from which the user may receive web services provided by provider server 130-2. For example, provider server 130-2 may provide online blog services, email services, and/or other online services to user device 110 via the web site.

If the user, via user device 110, has not visited the web site provided by provider server 130-1 and/or has not received cookie 340 from provider server 130-1 (FIG. 3), user device 110 may provide an IP address 430 of user device 110 to provider server 130-2. Provider server 130-2 may provide IP address 430 to ad server 120, and ad server 120 may receive IP address 430. Based on IP address 430, ad server 120 may attempt to retrieve the user profile (e.g., from the database associated with ad server 120). If ad server 120 successfully retrieves the user profile, ad server 120 may provide ad 420 to user device 110, via provider server 130-2, as described above in connection with FIG. 4A. However, if ad server 120 unsuccessfully retrieves the user profile, ad server 120 may determine a location of the user based on IP address 430. It may be assumed in this example that the user is located at a location that is supported by products and/or services provided by provider server 130-1 (FIG. 3), as indicated by reference number 440. Ad server 120 may determine that the location is supported and may determine an ad 450 customized to the location of the user. Ad 450 may include a banner ad, or some other type of online ad, that is unique to the location of the user, such as advertisements for products and/or services offered in a particular zip code or city by the entity associated with provider server 130-1.

As further shown in FIG. 4B, ad server 120 may provide ad 450 to provider server 130-2, and provider server 130-2 may embed ad 450 into a web site provided to user device 110. Ad 450 may attempt to attract traffic to the web site of provider server 130-1 (FIG. 3) by linking to the web site of provider server 130-1. In one example, ad 450 may include an image, and may employ animation, sound, and/or video to maximize presence. Provider server 130-2 may provide ad 450 to user device 110, via the web site provided by provider server 130-2. Ad 450 may be displayed to the user when a web site provided by provider server 130-2 is loaded into the web browser of user device 110. If the user, via user device 110, selects ad 450, user device 110 may be redirected to the web site provided by provider server 130-1 (FIG. 3).

As shown in FIG. 4C, the user, via user device 110, may access the web site provided by provider server 130-2, as indicated by reference number 410. In one example implementation, provider server 130-2 may provide a web site, to user device 110, from which the user may receive web services provided by provider server 130-2. For example, provider server 130-2 may provide online sports services, game services, and/or other online services to user device 110 via the web site.

If the user, via user device 110, has not visited the web site provided by provider server 130-1 and/or has not received cookie 340 from provider server 130-1 (FIG. 3), user device 110 may provide IP address 430 of user device 110 to provider server 130-2. Provider server 130-2 may provide IP address 430 to ad server 120, and ad server 120 may receive IP address 430. Based on IP address 430, ad server 120 may attempt to retrieve the user profile (e.g., from the database associated with ad server 120). If ad server 120 successfully retrieves the user profile, ad server 120 may provide ad 420 to user device 110, via provider server 130-2, as described above in connection with FIG. 4A. However, if ad server 120 unsuccessfully retrieves the user profile, ad server 120 may determine a location of the user based on IP address 430. It may be assumed in this example that the user is located at a location that is not supported by products and/or services provided by provider server 130-1 (FIG. 3), as indicated by reference number 460. Ad server 120 may determine that the location is not supported, and may determine a generic ad 470 for the user in such a scenario. Generic ad 470 may include a banner ad, or some other type of online ad, that is unique to the region of the user, such as advertisements for products and/or services offered in particular states by the entity associated with provider server 130-1. Alternatively, or additionally, generic ad 470 may include advertisements providing general information about the entity associated with provider server 130-1.

As further shown in FIG. 4C, ad server 120 may provide generic ad 470 to provider server 130-2, and provider server 130-2 may embed generic ad 470 into a web site provided to user device 110. Generic ad 470 may attempt to attract traffic to the web site of provider server 130-1 (FIG. 3) by linking to the web site of provider server 130-1. In one example, generic ad 470 may include an image, and may employ animation, sound, and/or video to maximize presence. Provider server 130-2 may provide generic ad 470 to user device 110, via the web site provided by provider server 130-2. Generic ad 470 may be displayed to the user when a web site provided by provider server 130-2 is loaded into the web browser of user device 110. If the user, via user device 110, selects generic ad 470, user device 110 may be redirected to the web site provided by provider server 130-1 (FIG. 3).

Although FIGS. 4A-4C show example components of network portion 400, in other implementations, network portion 400 may include fewer components, different components, differently arranged components, or additional components than depicted in FIGS. 4A-4C. Additionally, or alternatively, one or more components of network portion 400 may perform one or more other tasks described as being performed by one or more other components of network portion 400.

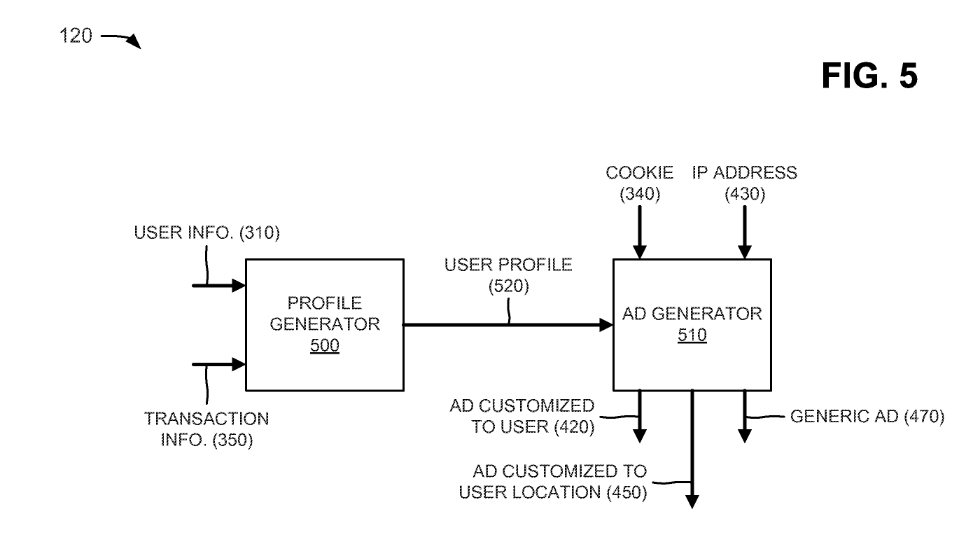

FIG. 5 is a diagram of example functional components of ad server 120. In one implementation, the functions described in connection with FIG. 5 may be performed by one or more components of device 200 (FIG. 2) or by one or more devices 200. As shown in FIG. 5, ad server 120 may include a profile generator 500 and an ad generator 510.

Profile generator 500 may receive user information 310 and transaction information 350, and may generate a user profile 520 based on user information 310 and/or transaction information 350. User profile 520 may include a name, a home address, a telephone number, credit card information, a shipping address, etc. associated with the user; an IP address, a model number, a manufacturer, etc. associated with user device 110; information associated with transactions performed by the user when the user visits the web site provided by provider server 130-1; etc. As further shown in FIG. 5, profile generator 500 may provide user profile 520 to ad generator 510 and to a database (not shown) associated with ad server 120.

Ad generator 510 may receive user profile 520 from profile generator 500, and may receive cookie 340 and/or IP address 430 from provider server 130-2 (not shown). If ad generator 510 receives cookie 340, ad generator 340 may generate ad 420 customized to the user. If ad generator 510 receives IP address 430, ad generator 340 may determine a user location based on IP address 430, and may generate ad 450 customized to the user location or may generate generic ad 470 depending on whether the user location is supported by products and/or services offered by the entity associated with provider server 130-1 (not shown). Ad generator 510 may provide ad 420, ad 450, or generic ad 470 to provider server 130-2 (not shown).

Although FIG. 5 shows example functional components of ad server 120, in other implementations, ad server 120 may include fewer functional components, different functional components, differently arranged functional components, or additional functional components than depicted in FIG. 5. Additionally, or alternatively, one or more functional components of ad server 120 may perform one or more other tasks described as being performed by one or more other functional components of ad server 120.

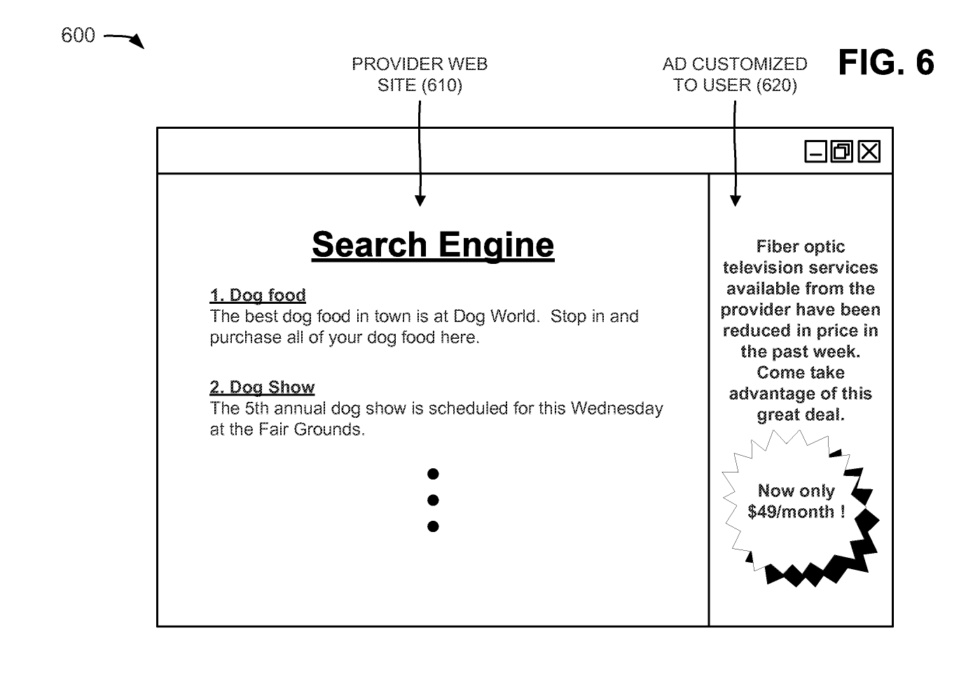

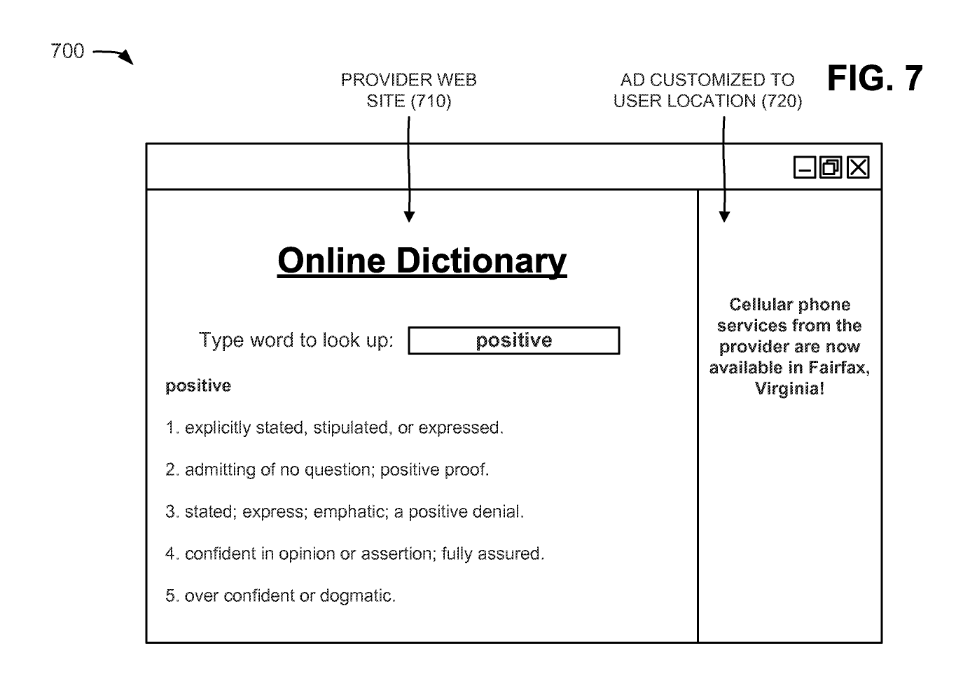

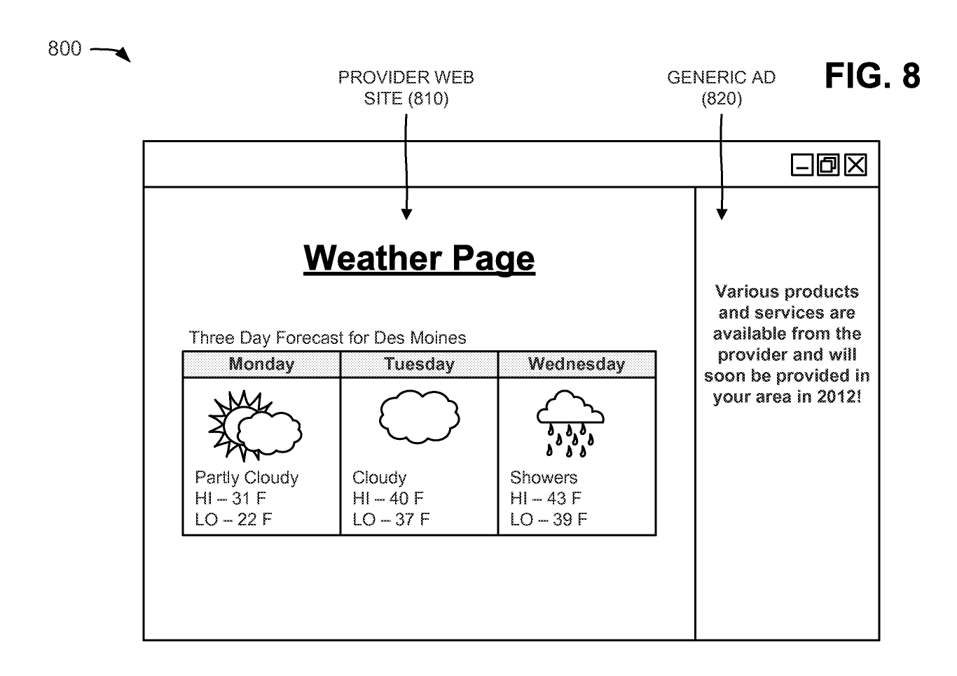

FIG. 6 is a diagram of an example user interface 600 capable of being generated or provided by user device 110, ad server 120, and/or provider server 130. User interface 600 depicted in FIG. 6, as well as user interfaces 700 and 800 depicted in FIGS. 7 and 8, respectively, (hereinafter referred to collectively as “the user interfaces”) may include graphical user interfaces (GUIs) or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices (e.g., input device 240, FIG. 2), may be user-configurable (e.g., a user may change the size of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user of user device 110 (e.g., via a touch screen display, a mouse, a keyboard, a keypad, etc.).

As shown in FIG. 6, user interface 600 may include a provider web site 610 and an ad 620 customized to a user. Provider web site 610 may include a web site provided by provider servers 130 other than the particular provider server (e.g., provider server 130-1). For example, provider web site 610 may include a web site that provides search engine services to the user of user device 110. Ad 620 may include the features described above in connection with ad 420 (FIG. 4A). For example, if the user reviewed but did not purchase television services offered by the particular provider server 130-1 because of price, ad 620 may include information promoting the television services to the user at a lower price (e.g., reduced to $49/month in the past week). Since the user originally did not purchase the television services because of the price, providing such an ad 620 may entice the user to reconsider and/or purchase the television services.

As shown in FIG. 7, user interface 700 may include a provider web site 710 and an ad 720 customized to a location of a user. Provider web site 710 may include a web site provided by provider servers 130 other than the particular provider server (e.g., provider server 130-1). For example, provider web site 710 may include a web site that provides online dictionary services to the user of user device 110. Ad 720 may include the features described above in connection with ad 450 (FIG. 4B). For example, if the user did not access the web site provided by the particular provider server 130-1 but the user is at a location supported by products and/or services offered by provider server 130-1, ad 720 may include information unique to the location of the user, such as advertisements for products and/or services offered in a particular zip code or city by the entity associated with provider server 130-1. As further shown in FIG. 7, in one example, ad 720 may include information about cellular phone services now available in Fairfax, Va. from the entity associated with provider server 130-1.

As shown in FIG. 8, user interface 800 may include a provider web site 810 and a generic ad 820. Provider web site 810 may include a web site provided by provider servers 130 other than the particular provider server (e.g., provider server 130-1). For example, provider web site 810 may include a web site that provides weather services to the user of user device 110. Generic ad 820 may include the features described above in connection with generic ad 470 (FIG. 4C). For example, if the user did not access the web site provided by the particular provider server 130-1 and the user is at a location unsupported by products and/or services offered by provider server 130-1, generic ad 820 may include information about products and/or services offered in particular states by the entity associated with provider server 130-1, general information about the entity associated with provider server 130-1, etc. As further shown in FIG. 8, in one example, generic ad 820 may include information about various products and/or services available from the entity associated with provider server 130-1.

Although user interfaces 600-800 of FIGS. 6-8 depict a variety of information, in other implementations, user interfaces 600-800 may depict less information, different information, differently arranged information, or additional information than depicted in FIGS. 6-8.

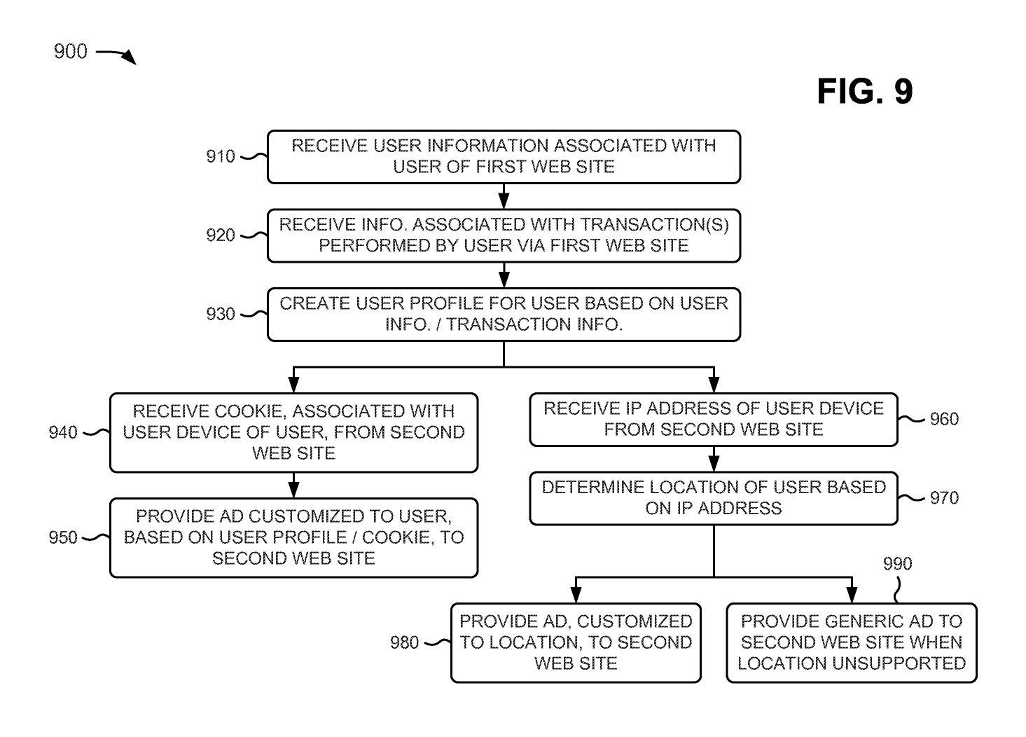

FIG. 9 is a flow chart of another example process 900 for providing dynamic user customized web advertisements according to an implementation described herein. In one implementation, process 900 may be performed by ad server 120. Alternatively, or additionally, some or all of process 900 may be performed by another device or group of devices, including or excluding ad server 120.

As shown in FIG. 9, process 900 may include receiving user information associated with a user of a first web site (block 910), and receiving information associated with transaction(s) performed by the user via the first web site (block 920). For example, in an implementation described above in connection with FIG. 3, provider server 130-1 may provide a web site, to user device 110, from which the user may review and/or purchase a variety of products and/or services offered by provider server 130-1. The user may provide user information 310 to user device 110, and user device 110 may provide user information 310 to provider server 130-1. User information 310 may include a name, a home address, a telephone number, credit card information, a shipping address, etc. associated with the user, an IP address associated with user device 110, etc. Provider server 130-1 may provide user information 310 and/or transaction information 350, associated with the user, to ad server 120. Transaction information 350 may include information associated with transactions performed by the user when the user visits the web site provided by provider server 130-1.

As further shown in FIG. 9, process 900 may include creating a user profile for the user based on the user information and/or the transaction information (block 930). For example, in an implementation described above in connection with FIG. 3, ad server 120 may utilize user information 310 and/or transaction information 350 to create a user profile for the user. The user profile may include user information 310 and/or transaction information 350. Alternatively, or additionally, ad server 120 may receive the user profile directly from provider server 130-1 or from an entity associated with provider server 130-1 (e.g., a business partner). Ad server 120 may store the user profile in a database associated with ad server 120.

Returning to FIG. 9, process 900 may include receiving a cookie, associated with a user device of the user, from a second web site (block 940), and providing an ad customized to the user, based on the user profile and/or the cookie, to the second web site (block 950). For example, in an implementation described above in connection with FIG. 4A, if the user, via user device 110, has visited the web site provided by provider server 130-1 and/or has received cookie 340 from provider server 130-1, user device 110 may provide cookie 340 to provider server 130-2. Provider server 130-2 may provide cookie 340 to ad server 120, and ad server 120 may receive cookie 340. Based on cookie 340, ad server 120 may retrieve the user profile, and may determine ad 420 based on the user profile and/or cookie 340. Ad 420 may include a banner ad, or some other type of online ad, that is unique to the user profile and/or transactions performed by the user on the web site provided by provider server 130-1.

As further shown in FIG. 9, process 900 may alternatively include receiving an IP address of the user device from the second web site (block 960) and determining a location of the user based on the IP address (block 970). For example, in an implementation described above in connection with FIG. 4B, if the user, via user device 110, has not visited the web site provided by provider server 130-1 and/or has not received cookie 340 from provider server 130-1, user device 110 may provide IP address 430 of user device 110 to provider server 130-2. Provider server 130-2 may provide IP address 430 to ad server 120, and ad server 120 may receive IP address 430. Ad server 120 may determine a location of the user based on IP address 430.

Returning to FIG. 9, process 900 may include providing, to the second web site, an ad customized to the location and when the location is supported (block 980) or providing a generic ad to the second web site when the location is unsupported (block 990). For example, in an implementation described above in connection with FIGS. 4B and 4C, ad server 120 may determine ad 450 customized to the location of the user. Ad 450 may include a banner ad, or some other type of online ad, that is unique to the location of the user, such as advertisements for products and/or services offered in a particular zip code or city by the entity associated with provider server 130-1. Ad server 120 may provide ad 450 to provider server 130-2, and provider server 130-2 may embed ad 450 into a web site provided to user device 110. Ad server 120 may determine generic ad 470 for the user when the location is unsupported by provider server 130-1. Generic ad 470 may include a banner ad, or some other type of online ad, that is unique to the region of the user or provides general information about the entity associated with provider server 130-1. Ad server 120 may provide generic ad 470 to provider server 130-2, and provider server 130-2 may embed generic ad 470 into a web site provided to user device 110.

Systems and/or methods described herein may provide web advertisements that are dynamically customized to a user based on a user profile and based on the user's transactions with a particular provider. For example, the systems and/or methods may generate dynamic ad content that is customized based on a user profile. The dynamic ad content may include service qualification information and/or product/price offering information. The systems and/or methods may determine the dynamic ad content expeditiously in order to provide the dynamic ad content as quickly as possible. For example, the systems and/or methods may utilize cloud computing services, synchronous technologies, and/or asynchronous technologies to quickly render the dynamic ad content. The systems and/or methods may enable the particular provider to retarget advertisements to the user with the user's specific interests and to communicate information about optimal products and/or services to the user via other provider web sites. The systems and/or method may also enable the particular provider to provide the products and/or services to the user in real time and to improve online channel sales at lower costs.

The foregoing description of implementations provides illustration and description, but is not intended to be exhaustive or to limit the implementations to the precise form disclosed. Modifications and variations are possible in light of the above teachings or may be acquired from practice of the implementations.

For example, while a series of blocks has been described with regard to FIG. 9, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by a device, information associated with a user of a user device;
receiving, by the device, information associated with one or more transactions performed by the user, via the user device, with a first web site;
creating, by the device, a user profile for the user based on the information associated with the user and based on the information associated with the one or more transactions;
receiving, by the device and from a second web site, a cookie associated with the user device;
retrieving, by the device, the user profile based on the cookie;
generating, by the device and based on the user profile, an advertisement customized to the user; and
providing, by the device and to the second web site, the advertisement customized to the user.

2. The method of claim 1, where the information associated with the user includes one or more of:
a name of the user,
a home address of the user,
a telephone number of the user,
credit card information associated with the user, or
a shipping address of the user.

3. The method of claim 1, where the information associated with the one or more transactions includes one or more of:
information associated with products or services viewed by the user via the first web site,
information associated with products or services purchased by the user via the first web site, or
information associated with whether the user accepts or denies products or services offered via the first web site.

4. The method of claim 1, where the advertisement customized to the user includes an online advertisement that is customized to the user profile and the one or more transactions performed by the user.

5. The method of claim 1, further comprising:
receiving, from the second web site, an Internet protocol (IP) address of the user device;
determining a location of the user device based on the IP address;
determining whether the location is supported by products or services offered by an entity associated with the first web site;
generating a different advertisement, customized to the location, when the location is supported by products or services offered by the entity; and
providing, to the second web site, the different advertisement customized to the location.

6. The method of claim 5, where the different advertisement customized to the location includes information associated with products or services offered in a particular zip code or city by the entity.

7. The method of claim 5, further comprising:
generating a generic advertisement when the location is unsupported by products or services offered by the entity; and
providing the generic advertisement to the second web site.

8. The method of claim 7, where the generic advertisement includes general information about the entity.

9. A device, comprising:
a memory; and
a processor to:
receive a user profile associated with a user of a user device, where the user profile is generated based on information associated with one or more transactions performed by the user, via the user device, with a first web site,
receive, from a second web site, a cookie associated with the user device,
generate, based on the user profile and when the cookie is received, an advertisement customized to the user, and
provide, to the second web site, the advertisement customized to the user.

10. The device of claim 9, where the user profile includes one or more of:
a name of the user,
a home address of the user,
a telephone number of the user,
credit card information associated with the user, or
a shipping address of the user.

11. The device of claim 9, where the information associated with the one or more transactions includes one or more of:
information associated with products or services viewed by the user via the first web site,
information associated with products or services purchased by the user via the first web site, or
information associated with whether the user accepts or denies products or services offered via the first web site.

12. The device of claim 9, where the advertisement customized to the user includes information customized to the user profile and the one or more transactions performed by the user.

13. The device of claim 9, where the processor is further to:
receive, from the second web site, an Internet protocol (IP) address of the user device,
determine a location of the user device based on the IP address,
determine whether the location is supported by products or services offered by an entity associated with the first web site,
generate a different advertisement, customized to the location, when the location is supported by products or services offered by the entity, and
provide, to the second web site, the different advertisement customized to the location.

14. The device of claim 13, where the different advertisement customized to the location includes information associated with products or services offered in a particular zip code or city by the entity.

15. The device of claim 13, where the processor is further to:
generate a generic advertisement when the location is unsupported by products or services offered by the entity, and
provide the generic advertisement to the second web site.

16. The device of claim 15, where the generic advertisement includes general information about the entity.

17. A computer-readable medium, comprising:
one or more instructions that, when executed by a processor of a device, cause the processor to:
receive information associated with a user of a user device,
receive information associated with one or more transactions performed by the user, via the user device, with a first web site,
create a user profile for the user based on the information associated with the user and based on the information associated with the one or more transactions,
receive, by the device and from a second web site, one of a cookie or an Internet protocol (IP) address associated with the user device,
generate, based on the user profile and when the cookie is received, an advertisement customized to the user, and
provide, to the second web site, the advertisement customized to the user.

18. The computer-readable medium of claim 17, where the information associated with the user includes one or more of:
a name of the user,
a home address of the user,
a telephone number of the user,
credit card information associated with the user, or
a shipping address of the user.

19. The computer-readable medium of claim 17, where the information associated with the one or more transactions includes one or more of:
information associated with products or services viewed by the user via the first web site,
information associated with products or services purchased by the user via the first web site, or
information associated with whether the user accepts or denies products or services offered via the first web site.

20. The computer-readable medium of claim 17, where the advertisement customized to the user includes information customized to the user profile and the one or more transactions performed by the user.

21. The computer-readable medium of claim 17, further comprising:
one or more instructions that, when executed by the processor of the device, cause the processor to:
determine, when the IP address is received, a location of the user device based on the IP address,
determine whether the location is supported by products or services offered by an entity associated with the first web site,
generate a different advertisement, customized to the location, when the location is supported by products or services offered by the entity, and
provide, to the second web site, the different advertisement customized to the location.

22. The computer-readable medium of claim 21, where the different advertisement customized to the location includes information associated with products or services offered in a particular zip code or city by the entity.

23. The computer-readable medium of claim 21, further comprising:
one or more instructions that, when executed by the processor of the device, cause the processor to:
generate a generic advertisement when the location is unsupported by products or services offered by the entity, and
provide the generic advertisement to the second web site.

24. The computer-readable medium of claim 23, where the generic advertisement includes general information about the entity.
